(19) United States
(12) Patent Application Publication
(10) Pub. No.: US 2024/0191611 A1
(43) Pub. Date: Jun. 13, 2024

(54) PERIODIC PREDICTIVE DRILLING BASED ON ACTIVE AND HISTORIC DATA

(71) Applicant: Halliburton Energy Services, Inc., Houston, TX (US)

(72) Inventors: Daniel Michael Antonio, Houston, TX (US); Andreas Sadlier, Houston, TX (US); Alexander Simon Chretien, Houston, TX (US); Syed Omar Alam, Houston, TX (US)

(21) Appl. No.: 18/078,663

(22) Filed: Dec. 9, 2022

(51) Int. Cl. E21B 44/00

(52) U.S. Cl. CPC E21B 44/00; E21B 2200/22

(57) ABSTRACT

A method comprises receiving active data of a number of time series datasets for different attributes of an active drilling operation of an active well, for a previous time period having a defined length of time and retrieving historic data, that corresponds to the active data, of the number of attributes for offset drilling operations of a number of selected reference wells. The method includes selecting a subset of the historic data that satisfies a relevancy threshold based on relevancy to the active data, wherein the selecting is based on similarities between the number of time series datasets in the active data and the historic data. The method includes creating a predictive composite logging, for a future time period, that includes a number of predictive times series datasets for at least a portion of the different attributes based on the selected subset of the historic data.

### BACKGROUND

The disclosure generally relates to drilling of wellbores and more particularly, to periodic predictive drilling based on active and historic data.

Most drilling operations summarize drilling activity for a previous period (e.g., a day) in a drilling report. These reports are often generated through a combination of manual and automated processes. While providing a summary of the previous period, these reports include little, if any, information on what is likely to occur in the future. Without a concise and easily accessible way to prepare, little effort is spent preparing for what could happen in the near future. This leads to reactionary decision making, lost time, and reduced efficiency during the subsequent drilling operations.

### BRIEF DESCRIPTION OF THE DRAWINGS

Embodiments of the disclosure may be better understood by referencing the accompanying drawings.

FIG. 1 depicts an example system for periodic predictive drilling based on active and historic data, according to some embodiments.

FIG. 2 depicts an example data flow diagram for periodic predictive drilling based on active and historic data, according to some embodiments.

FIGS. 3-4 depict a flowchart of example operations for periodic predictive drilling based on active and historic data, according to some embodiments.

FIG. 5 depicts an example computer, according to some embodiments.

### DESCRIPTION

The description that follows includes example systems, methods, techniques, and program flows that embody aspects of the disclosure. However, it is understood that this disclosure may be practiced without these specific details. For instance, this disclosure refers to daily processing and generating of predictive logging and drilling reports in illustrative examples. Aspects of this disclosure can also be applied to other time periods (e.g., weekly, monthly, etc.) formation samples during other stages of wellbore operations. For example, aspects of this disclosure may also be applied to analysis of formation samples during post drilling operations (such as a production operation). In other instances, well-known instruction instances, protocols, structures, and techniques have not been shown in detail in order not to obfuscate the description.

Typically, there may be large volumes of data that are collected during drilling operations across a number of different wells. The data may include time series datasets regarding different drilling attributes or variables (e.g., weight on bit (WOB), rate of penetration (ROP), etc.) and key drilling factors (e.g., types of equipment, size of the wellbore, etc.). As part of conventional drilling operations, this data from a previous time period can be processed and summarized. Such data may be combined with user input to create a periodic (e.g., daily) drilling report—which may be used to assess the current drilling operations. Examples of user input may include a user's observations of the drilling activity, changes in personnel, etc.

In contrast to a conventional drilling report, example implementations include a predictive logging for a future time period for drilling the active well. In some example embodiments, this predictive logging may be derived by comparing the data from the previous periodic drilling report for the active well to these large volumes of data from other wells that may be similar to the active well. For example, data from other wells for a given time period that have had events, progress, drilling equipment, type of formation being drilled, etc. that are similar to those in the previous periodic drilling period for the active well may be used for comparison to the data in the previous periodic drilling period for the active well to create a predictive logging. In some example embodiments, a predictive drilling report can be created from the predictive logging. Such a predictive drilling report may have a similar look and feel, data, formatting, etc. as a conventional periodic drilling report. As an example, the predictive drilling report may predict how far the depth of the wellbore will increase for the future time period, events that may likely occur during this future time period, etc. In some embodiments, the predictive drilling report may also include one or more corrective actions that may be taken to avoid or mitigate certain predicted events. Examples of such events may include the drill pipe sticking, drill pipe being twisted off, drilling fluid losses into the formation, premature drill bit wear, wellbore blowout, wellbore cave in, etc. Thus, example implementations may use active data from the active well that is actively being drilled to determine historic data from comparative drilling periods from selected reference wells to generate a drilling report predicting what may occur in a future time period (e.g., the next 24 hours).

Example implementations may include automated drilling report notification to a historic archive or database. Also, example implementations may include pattern matching of historic data to active data for the purpose of correlating the historic data with the active data. Historic data may be combined to create a predictive report based on historic similarities with the active data.

By updating the expected outcome with periodic (e.g., daily) active data in an actionable format like a periodic drilling report, personnel at the drilling site of the active well can better prioritize scenario planning efforts. Additionally, example implementations may proactively mitigate risks of drilling the active well by having advanced knowledge of what events are likely to occur in the near future (using the predictive logging and predictive drilling reports).

Example implementations may include operations that begin with the collection of active data in a centralized database. From this database on a scheduled basis (e.g., every 24 hours), the relevant data to preparing a daily drilling report may be collected. Examples of time series datasets of drilling attributes that are detected and stored may include depth of the wellbore, time, rate of penetration (ROP) of the drilling of the wellbore, weight on bit (WOB) of the drill bit, torque on the drill string, rotations per minute (RPM) of the drill string, inclination, azimuth, SPP, pit volumes, connection time, activity state, relevant formation evaluation attributes (such as gamma, resistivity as well as any other time-series curves/variables that were determined to be relevant during well planning). The active data may be integrated into a current daily report. This report may then be automatically distributed to the appropriate personnel as well as stored in a historic archive. Additionally, this generation and/or distribution of this drilling report may initiate operations to create a predictive log and predictive drilling report for a future time period (as further described herein).

In some implementations, operations to generate the predictive drilling report may begin by determining which reference wells are to be selected. The historic data from these selected reference wells may be used to generate the predictive drilling report. In some embodiments, selection of these reference wells may be based on at least one or user input, geographic location, type of drilling (e.g., horizontal, slanted, vertical, etc.), type of subsurface formation into which the wellbore is being drilled, type of drilling equipment (e.g., drill bit), etc.

These selected reference wells may be identified at the start of the operations and be associated with the active well for which active data is provided for periodic updates on the drilling operations. The historic data from these selected reference wells (along with the active data for a previous time period (e.g., previous 24 hours)) can be input into a machine-learning model. The machine-learning model may perform a comparison between this active data and the historic data from the selected reference wells. For example, the data in the historic data and the active data that is being compared may include key drilling factors (such as types of drilling equipment (e.g., drill bit, bottom hole assembly, etc.) and time series datasets (e.g., depth, ROP, WOB, etc.). The machine-learning model may use pattern matching and other machine learning algorithms to identify similarities between the historic data and the active data. The machine-learning model may output the most relevant historic data based on these similarities. The most relevant historic data may include time series datasets and key drilling factors for one or more time periods from one or more of the selected reference wells.

From this predictive log, a future or predictive periodic (e.g., daily) drilling report may be created using a same or similar process used to generate the current periodic drilling report. Thus, a primary difference between a predictive periodic drilling report and a current periodic drilling report may be the input data. In particular, rather than using the current active data for a current periodic drilling report, a predictive log may be used to generate a future periodic drilling report today.

While example embodiments are described such that the historic data is stored in a data lake, in some other embodiments, a historic database with a schema matching the requirements needed for operations described herein can suffice as a source. While described such that the active data is stored in a centralized active database that is storing data for drilling of multiple active wells, in some implementations, the active data can be located at a single storage device at or near the drilling site. Also, example embodiments are described using time series datasets. However, in some implementations, depth-based datasets may be used to provide analysis between the active well and the selected referenced wells (rather than time series datasets). Additionally, for time series datasets, such datasets may need to be normalized to the start of periodic time period (e.g., each 24-hour period).

Example implementations may compare what occurred for a previous time period at the active well to time periods that includes similar events and/or progress at operations that occurred at selected reference wells (previously drilled). Example implementations may then leverage the events and activities that occurred after those similar events and/or progress in the selected reference wells to generate a predictive log of what is likely to occur in the future for the active well. Example implementations may use a machine-learning model to identify similarities between the previous time period for the active well and time periods for the selected reference wells. Examples of such similarities may include similar subsurface formation being drilled, type of equipment being used for the drilling, type of drilling (e.g., vertical, horizontal, slanted, etc.). Based on comparison of these similarities, the machine-learning model can output a subset of the historic data of these selected reference wells.

### Example System

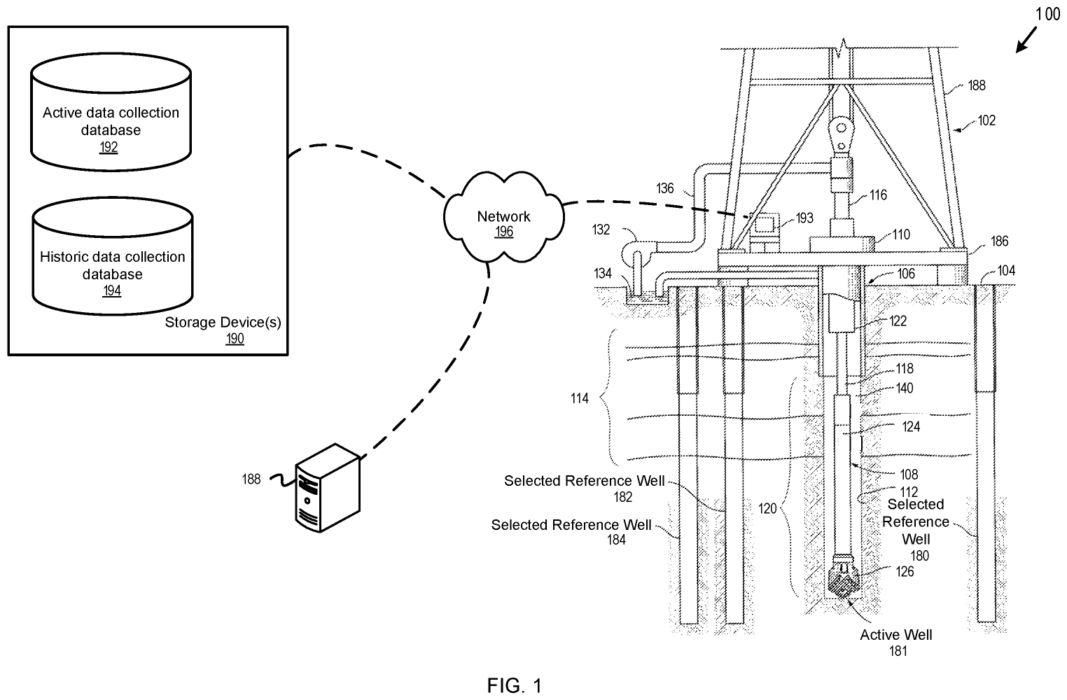

FIG. 1 depicts an example system for periodic predictive drilling based on active and historic data, according to some embodiments. FIG. 1 depicts a drilling system (hereinafter system) 100 for drilling an active well 181. FIG. 1 also depicts a number of selected reference wells (a selected reference well 180, a selected reference well 182, and a selected reference well 184) that have previously been drilled.

FIG. 1 also depicts a network 196 that is communicatively coupled to a logging device 193 of the system 100, a data storage 190, and a computer 188. All or parts of the network 196, the data storage 190, and the computer 188 may be remote from the drill site of the system 100. The data storage 190 includes an active data collection database 192 and a historic data collection database 194. As further described below, example embodiments may use data from a previous time period from the active well 181 to identify similar time periods of selected reference wells (previously drilled). Historic data for these similar time periods of selected reference wells may be used to create predictive logs that includes predicted values for data (such as time series data sets of different relevant drilling attributes (such as ROP, WOB, etc.) for a future time period of the active well. The historic data from the similar previous drilling operations may be stored in the historic data collection database 194. Such data may include time-series historic drilling data (such as data used to populate daily drilling reports).

As part of drilling the active well 181, a string of drill pipes connected together so as to form a drilling string that is lowered through a rotary table 110 into a wellbore 106. The system 100 may include a drilling rig 102 located at a surface 104 of the wellbore 106. The drilling rig 102 may provide support for a drill string 108. The drill string 108 may operate to penetrate the rotary table 110 for drilling the wellbore 106 through subsurface formations 114. The drill string 108 may include a Kelly 116, drill pipe 118, and a bottom hole assembly 120, that may be located at the lower portion of the drill pipe 118.

The bottom hole assembly 120 may include drill collars 122, a downhole tool 124, and a drill bit 126. The drill bit 126 may operate to create the wellbore 112 by penetrating the surface 104 and subsurface formations 114. The downhole tool 124 may comprise any of a number of different types of tools including MWD (measurement while drilling) tools, LWD tools, and others.

During drilling operations, the drill string 108 (perhaps including the Kelly 116, the drill pipe 118, and the bottom hole assembly 120) may be rotated by the rotary table 110. In addition to, or alternatively, the bottom hole assembly 120 may also be rotated by a motor (e.g., a mud motor) that is located downhole. The drill collars 122 may be used to add weight to the drill bit 126. The drill collars 122 may also operate to stiffen the bottom hole assembly 120, allowing the bottom hole assembly 120 to transfer the added weight to the drill bit 126, and in turn, to assist the drill bit 126 in penetrating the surface 104 and subsurface formations 114.

During drilling operations, a mud pump 132 may pump drilling fluid (sometimes known by those of skill in the art as “drilling mud”) from a mud pit 134 through a hose 136 into the drill pipe 118 and down to the drill bit 126. The drilling fluid can flow out from the drill bit 126 and be returned to the surface 104 through an annular area 140 between the drill pipe 118 and the sides of the wellbore 112. The drilling fluid may then be returned to the mud pit 134, where such fluid is filtered. In some embodiments, the drilling fluid can be used to cool the drill bit 126, as well as to provide lubrication for the drill bit 126 during drilling operations. Additionally, the drilling fluid may be used to remove subsurface formation 114 cuttings created by operating the drill bit 126.

The system 100 also includes a logging device 193 located at the surface of the wellbore 106. During drilling operations, downhole tool 124 may perform measurements. The measurement data can be communicated to the logging device 193 for storage, processing, and analysis. The logging device 193 may be provided with electronic equipment for various types of signal processing. The log data is similar to that which may be gathered and analyzed during drilling operations (e.g., during logging while drilling (LWD) operations).

### Example Operations

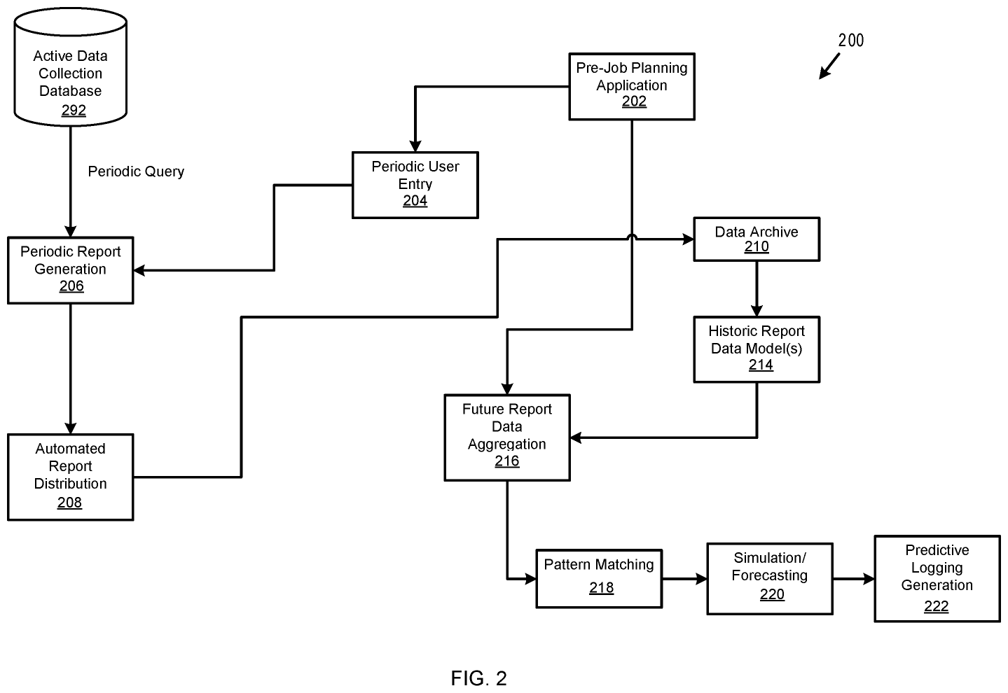

FIG. 2 depicts an example data flow diagram for periodic predictive drilling based on active and historic data, according to some embodiments. FIG. 2 depicts a data flow diagram 200 that is initiated with the execution of a pre-job planning application 202 for an active well. After the pre-job planning application 202, periodic (e.g., daily) user entry 204 for the active well may also occur regarding the drilling operations of the active well. A periodic report generation 206 for the active well occurs based data from an active data collection database 292 for the previous periodic time period and the periodic user entry 204. The generated periodic report is then input into an automated report distribution 208. The automated report distribution 208 can store the periodic report for the active well into a data archive 210. This stored periodic report can be input from the data archive 210 into historic report data model(s) 214

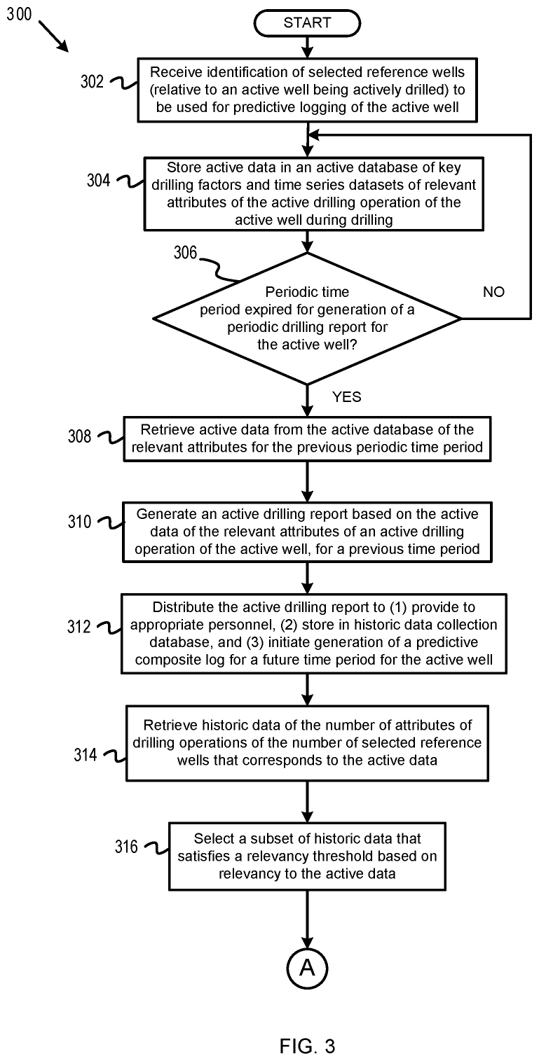

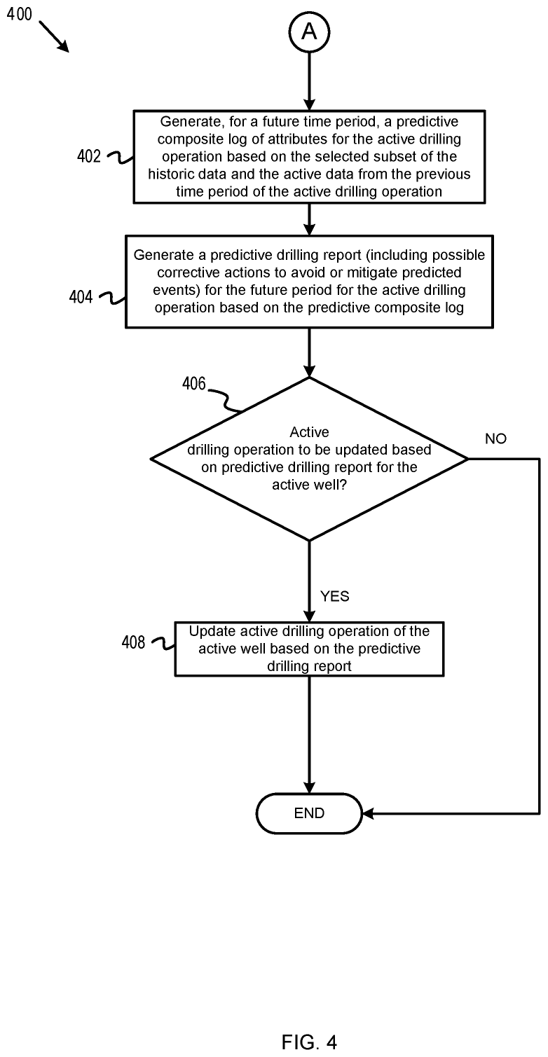

The selected historic data model(s) can be input into a future report data aggregation 216. Output from the pre-job planning application 202 can also be input into the future report data aggregation 216. Output from the future report data aggregation 216 is input into a pattern matching 218 to identify historic data that is similar to the active data for the periodic report just generated for the active well. Output from the pattern matching 218 includes subsets of the historic data from selected reference wells that may be used to predict future predictive logs for the active well. This output is input into simulation/forecasting 220. The simulation/forecasting 220 can output predicted values for different drilling attributes for the active well based on the subsets of historic data. Output from the simulation/forecasting 220 can be inputted into a predictive logging generation 222, which can output a predictive log for the active well based on the predicted values. Further description of these operations is now described in reference to FIGS. 3-4.

FIGS. 3-4 depict a flowchart of example operations for periodic predictive drilling based on active and historic data, according to some embodiments. Operations of flowcharts 300-400 of FIGS. 3-4 continue between each other through transition point A. Operations of the flowcharts 300-400 can be performed by software, firmware, hardware, or a combination thereof. Operations of the flowcharts 300-400 are described in reference to the example system depicted in FIG. 1. However, other systems and components can be used to perform the operations now described. The operations of the flowchart 300 start at block 302.

At block 302, identification of selected reference wells (relative to an active well being actively drilled) to be used for predictive logging of the active well is received. For example, with reference to FIG. 1, the computer 188 may receive identification of the selected reference wells. The computer 188 may receive identification of the selected reference wells from one or more sources. Examples of such sources may include user input, computer operations to identify the selected reference wells based on similar formations being drilled, geologic proximity relative to the active well, similar types of key drilling factors (such as type of equipment, size of wellbore being drilled, etc.).

At block 304, active data is stored in an active database of relevant attributes of the active drilling operation of the active well during drilling. For example, with reference to FIG. 1, the computer 188 may store active data into the active data collection database 192. Examples of such active data may include key drilling factors (such as type of equipment, size of wellbore being drilled, etc.) and time series datasets for different drilling attributes that may change over time. Examples of such time series datasets may include depth of the wellbore, time, rate of penetration (ROP) of the drilling of the wellbore, weight on bit (WOB) of the drill bit, torque on the drill string, rotations per minute (RPM) of the drill string, inclination, azimuth, SPP, pit volumes, connection time, activity state, relevant formation evaluation attributes (such as gamma, resistivity as well as any other time-series curves/variables that were determined to be relevant during well planning). Connection time may be the time needed to stop drilling in order to connect additional drill pipe to the drill string to continue drilling the wellbore. Activity state may be a state of the drilling operation. Examples of an activity state include actual drilling ahead, drilling but no stuck at a same depth, no actual drilling for different reasons (such as adding more drill pipe, make adjustments, clearing out the wellbore, tripping in, tripping out, etc.), etc. Also, such active data may be stored for a given time period (such as the last 24 hours).

At block 306, a determination is made of whether a periodic time period expired for generation of a periodic drilling report for the active well. For example, with reference to FIG. 1, the computer 188 may make this determination. In some implementations, the periodic time period may be 24 hours, weekly, monthly, quarterly, etc. For instance, a periodic drilling report for the active well may be generated every 24 hours. If the periodic time period has not expired for generation of the periodic drilling report of the active well, operations of the flowchart 300 return to block 304. Otherwise, operations of the flowchart 300 continue at block 308.

At block 308, active data is retrieved from the active database of the relevant attributes for the previous periodic time period. For example, with reference to FIG. 1, the computer 188 may retrieve the active data for the previous periodic time period (e.g., 24 hours) from the active data collection database 192.

At block 310, an active drilling report is generated based on the active data of the relevant attributes of an active drilling operation of the active well, for the previous time period. For example, with reference to FIG. 1, the computer 188 may generate the active drilling report. This active drilling report may include valuable insight and data on what occurred during drilling in a previous time period (e.g., last 24 hours). Such a report can include user inputs or comments about the previous drilling period, drilling attributes, and summaries or calculations based on the drilling attributes.

At block 312, the active drilling report is distributed to appropriate personnel, to store in historic data collection database, and to initiate generation of a predictive composite log for a future time period for the active well. For example, with reference to FIG. 1, the computer 188 may perform this distribution and storage. Additionally, the generation of the active drilling report may initiate generate of a predictive composite log for a future time period for the active well.

At block 314, historic data of the number of attributes of drilling operations of the number of selected reference wells that corresponds to the active data is retrieved. For example, with reference to FIG. 1, the computer 188 may retrieve the historic data across multiple time periods for each of the selected reference wells 180-184 from the historic data collection database 194.

At block 316, a subset of historic data that satisfies a relevancy threshold based on relevancy to the active data is selected. For example, with reference to FIG. 1, the computer 188 may perform this operation. For instance, the computer 188 may input the corresponding historic data and the active data into a machine-learning model. The machine-learning model may determine similarities between the corresponding historic data and the active data. For example, the machine-learning model may determine patterns in the active data. For instance, the ROP was at a given value for a defined amount of time, while the gamma rays (as part of a formation logging) had a defined pattern, etc. The machine-learning model may then select one or more periods of historic data from one or more selected reference wells that have a same or similar pattern for these time series datasets. The machine-learning model may then output these one or more periods of historic data as the subset of historic data. These subsets of historic data may be considered to define a relevancy threshold based on how similar the data is to the active data.

In some implementations, the subset of historic data that is selected may include time periods for the drilling from one or more selected reference wells that may be considered an analog to the previous time period at the active well. These time periods for the drilling of the one or more selected reference wells may or may not correspond to relative time and/or relative depth of the previous time period at the active well. For example, assume that the relative time of the previous time period is a fourth day of drilling of the active well. A time period for the drilling of the selected reference wells may be a 10th day of drilling. In another example, assume that the relative depth of the previous time period is 100-200 feet. The relative depth of the selected reference well that was drilled for the given time period may be 400-500 feet.

Operations of the flowchart 300 continue at transition point A, which continues at transition point A of the flowchart 400, which is now described. From transition point A of the flowchart 400, operations continue at block 402.

At block 402, a predictive composite log of attributes for the active drilling operation is generated, for a future time period, based on the selected subset of the historic data. For example, with reference to FIG. 1, the computer 188 may retrieve the historic data in a subsequent period following each period within the subset of historic data. Because of the similarities with the active data, this historic data in the subsequent period(s) may be a basis of what is likely to occur in the future period for the active well.

For each selected dataset from the selected reference wells, the computer 188 may then retrieve the subsequent dataset for the subsequent time period for these selected reference wells from the historic data. These subsequent datasets (which may include time-series data and key drilling factors) may be considered the best predictor what is most likely to occur in the future time period for the active well. For example, the subsequent datasets may include depth, ROP, WOB, resistivity logs that may be combined based on their weights to create the dataset for the predictive composite log for the future time period for the active well. This newly created dataset may then be used to populate the predictive composite log.

In some implementations, the computer 188 may combine historic data from these different subsequent periods for a given reference well or for multiple reference wells to create a predictive composite log of attributes for the active drilling operation for a future time period. To illustrate, assume that the historic data to be used includes a dataset #1 from reference well A for a time period X, a dataset #2 from reference well A for a time period Y, a dataset #3 from reference well B for a time period Z, a dataset #4 from reference well C for time period Z, etc. In some implementations, the different datasets may have different likelihood matches with the active data. For example, dataset #1 may have a likelihood match of 75%, dataset #2 may have a likelihood match of 25%, dataset #3 may have a likelihood match of 50%, and dataset #4 may have a likelihood match of 60%. In such implementations, these different datasets may have assigned different weights based on the likelihood matches. For example, a dataset with a higher likelihood match would be assigned a higher weight. Accordingly, the computer 188 may generate the predictive composite log of attributes for the active drilling operation based on different datasets and based on their different assigned weights. For example, the computer 188 may generate the predictive composite log that includes predictions of attributes such that a dataset with a higher weight is relied upon more than a dataset with a lower weight (in these predictions). In some implementations, this historic data may be combined into a predictive pseudo log based on predictive analytics and a multiple probability simulation (e.g., a Monte Carlo simulation).

At block 404, a predictive drilling report (including possible corrective actions to avoid or mitigate predicted events) is generated for the future period for the active drilling operation based on the predictive composite log. For example, with reference to FIG. 1, the computer 188 may generate the predictive drilling report. In some implementations, the predictive drilling report may have a same or similar format as a conventional daily drilling report that includes data, summaries, etc. of a previous time period (e.g., the last 24 hours). Thus, the predictive drilling report may include the same or similar calculations as those used for a conventional daily drilling report. However, a difference may be the inputs being used to generate the drilling reports. The predictive drilling report may rely on the datasets from the subsequent time periods for the selected datasets for the selected reference wells. In contrast, the conventional daily drilling report relies on the dataset from the previous time period for that active well.

The predictive drilling report may also include possible corrective actions to avoid or mitigate predicted events. For example, assume that the predictive drilling report is reporting that a pressure of the drilling fluid is likely to drop because the drilling fluid is leaking into the formation. Therefore, the predictive drilling report may include a recommendation to perform a given adjustment in the drilling to attempt to preclude or reduce this from occurring. In another example, assume that the predictive drilling report is reporting damage or unnecessary wear of the drill bit. Therefore, the predictive drilling report may include a recommendation to reduce WOB, speed of rotation of the drill string, etc. In another example, assume that the predictive drilling report is reporting that it is likely that the formation pressure is to increase in the upcoming drilling period. Therefore, the predictive drilling report may include a recommendation to increase the weight of the drilling fluid to prevent the wellbore from caving in, being unstable, etc.

In some implementations, the predictive drilling report may be compared to the actual drilling report for the given time period to determine how accurate the predictive drilling report was. Additionally, this comparison may be used as input in creating more accurate subsequent predictive composite logs and reports.

At block 406, a determination is made of whether the active drilling operation is to be updated based on predictive drilling report. For example, with reference to FIG. 1, the computer 188 may this determination. For instance, the parameters (such as WOB, TOB, ROP, etc.) for the active drilling operation of the active well can be adjusted based on the predictive drilling report. If it is determined that the active drilling operations is to be updated, operations of the flowchart 400 continue at block 408. Otherwise, operations of the flowchart 400 are complete.

At block 408, parameters for subsequent drilling operations are updated based on the predictive drilling report. For example, with reference to FIG. 1, the computer 170 can perform this update by transmitting control instructions to one or more components or devices at the drilling site. Operations of the flowchart 400 are complete.

### Example Computer

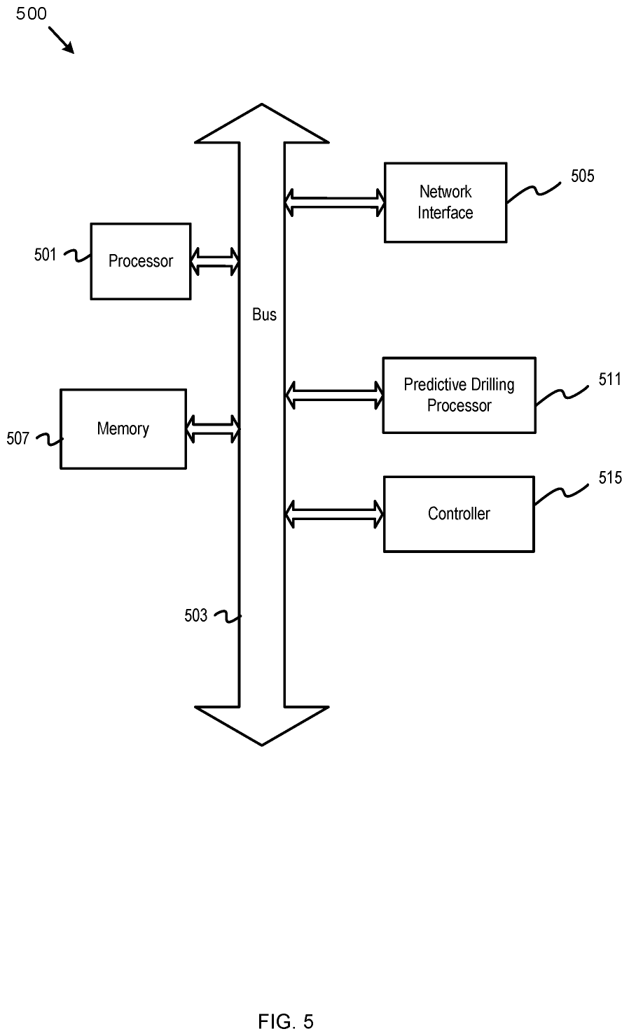

FIG. 5 depicts an example computer, according to some embodiments. FIG. 5 depicts a computer 500 that includes a processor 501 (possibly including multiple processors, multiple cores, multiple nodes, and/or implementing multi-threading, etc.). The computer 500 includes a memory 507. The memory 507 may be system memory or any one or more of the above already described possible realizations of machine-readable media. The computer 500 also includes a bus 503 and a network interface 505.

The computer 500 also includes a predictive drilling processor 511 and a controller 515. The predictive drilling processor 511 and the controller 515 can perform one or more of the operations described herein. For example, the predictive drilling processor 511 can perform one or more of the operations to generate the predictive composite logging and the predictive drilling report (as described above). The controller 515 can perform various control operations for adjusting the active drilling operation of the active well based on the predictive drilling report (as described above).

Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

While the aspects of the disclosure are described with reference to various implementations and exploitations, it will be understood that these aspects are illustrative and that the scope of the claims is not limited to them. In general, techniques for simulating drill bit abrasive wear and damage during the drilling of a wellbore as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing. Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

### EXAMPLE EMBODIMENTS

Embodiment #1: A method comprising: receiving active data of a number of time series datasets for different attributes of an active drilling operation of an active well, for a previous time period having a defined length of time; retrieving historic data, that corresponds to the active data, of the number of attributes for offset drilling operations of a number of selected reference wells; selecting a subset of the historic data that satisfies a relevancy threshold based on relevancy to the active data, wherein the selecting is based on similarities between the number of time series datasets in the active data and the historic data; and creating a predictive composite logging, for a future time period, that includes a number of predictive times series datasets for at least a portion of the different attributes based on the selected subset of the historic data.

Embodiment #2: The method of Embodiment #1, wherein selecting the subset of the historic data that satisfies the relevancy threshold comprises inputting the active data and the historic data into a machine-learning model to output from the machine-learning model the subset of the historic data that satisfies the relevancy threshold.

Embodiment #3: The method of one or more of Embodiments #1-2, wherein the selected subset of the historic data comprises historic data from at least two of the number of selected references wells.

Embodiment #4: The method of one or more of Embodiments #1-3, wherein at least a portion of the selected subset of the historic data is from a different depth interval for at least one of the number of selected reference wells as compared to a depth interval of the active well for the previous time period.

Embodiment #5: The method of one or more of Embodiments #1-4, wherein the previous time period is defined relative to a start of the active drilling operation, wherein at least a portion of the selected subset of the historic data is from a reference time period for at least one of the number of selected reference wells, wherein the reference time period is defined relative to a start of a reference drilling operation of an associated selected reference well, wherein the previous time period is different from the reference time period.

Embodiment #6: The method of one or more of Embodiments #1-5, wherein the predictive composite logging includes at least one non-time series attribute of the number of attributes, wherein the method further comprising: generating a predictive drilling report for the future time period based on the predictive composite logging.

Embodiment #7: The method of Embodiment #6, wherein the predictive composite logging includes at least one non-time series attribute of the number of attributes, and wherein the predictive drilling report comprises at least one text-based prediction of an event predicted to occur in the future time period.

Embodiment #8: The method of one or more of Embodiments #6-7, further comprising: determining whether the active drilling operation is to be updated based on the predictive drilling report; and in response to determining that the active drilling operation is to be updated based on the predictive drilling report, updating at least one parameter of the active drilling operation based on the predictive drilling report.

Embodiment #9: The method of one or more of Embodiments #1-8, wherein the number of attributes comprises at least one of a depth of a wellbore, a timestamp, a rate of drilling penetration, a weight on bit, a torque applied to a drill string, rotations per minute of the drill string, an inclination of the wellbore, an azimuth of the wellbore, a stand pipe pressure on the drill string, a pit volume, a connection time, an activity state, and at least one formation log.

Embodiment #10: A non-transitory, computer-readable medium having instructions stored thereon that are executable by a processor to perform operations comprising: receiving active data of a number of time series datasets for different attributes of an active drilling operation of an active well, for a previous time period having a defined length of time; retrieving historic data, that corresponds to the active data, of the number of attributes for offset drilling operations of a number of selected reference wells; selecting a subset of the historic data that satisfies a relevancy threshold based on relevancy to the active data, wherein the selecting is based on similarities between the number of time series datasets in the active data and the historic data; and creating a predictive composite logging, for a future time period, that includes a number of predictive times series datasets for at least a portion of the different attributes based on the selected subset of the historic data.

Embodiment #11: The non-transitory, computer-readable medium of Embodiment #10, wherein selecting the subset of the historic data that satisfies the relevancy threshold comprises inputting the active data and the historic data into a machine-learning model to output from the machine-learning model the subset of the historic data that satisfies the relevancy threshold.

Embodiment #12: The non-transitory, computer-readable medium of one or more of Embodiments #10-11, wherein the selected subset of the historic data comprises historic data from at least two of the number of selected references wells.

Embodiment #13: The non-transitory, computer-readable medium of one or more of Embodiments #10-12, wherein at least a portion of the selected subset of the historic data is from a different depth interval for at least one of the number of selected reference wells as compared to a depth interval of the active well for the previous time period.

Embodiment #14: The non-transitory, computer-readable medium of one or more of Embodiments #10-13, wherein the previous time period is defined relative to a start of the active drilling operation, wherein at least a portion of the selected subset of the historic data is from a reference time period for at least one of the number of selected reference wells, wherein the reference time period is defined relative to a start of a reference drilling operation of an associated selected reference well, wherein the previous time period is different from the reference time period.

Embodiment #15: The non-transitory, computer-readable medium of one or more of Embodiments #10-14, wherein the operations comprise: generating a predictive drilling report for the future time period based on the predictive composite logging; determining whether the active drilling operation is to be updated based on the predictive drilling report; and in response to determining that the active drilling operation is to be updated based on the predictive drilling report, updating at least one parameter of the active drilling operation based on the predictive drilling report.

Embodiment #16: The non-transitory, computer-readable medium of one or more of Embodiments #10-15, wherein the number of attributes comprises at least one of a depth of a wellbore, a timestamp, a rate of drilling penetration, a weight on bit, a torque applied to a drill string, rotations per minute of the drill string, an inclination of the wellbore, an azimuth of the wellbore, a stand pipe pressure on the drill string, a pit volume, a connection time, an activity state, and at least one formation log.

Embodiment #17: A system comprising: a drill string to drill an active well as part of an active drilling operation, wherein the drill string comprises a bottom hole assembly that includes a downhole tool to detect active data of at least one attribute of a number of attributes of the active drilling operation; a logging device to receive active data of the number of attributes of the active drilling operation; a storage device to store, an active data collection database that includes the active data of the number of attributes of the active drilling operation in the active data collection database; and a historic data collection database that includes historic data of the number of attributes for reference drilling operations of a number of selected reference wells; a processor; and a computer-readable medium having instructions stored thereon that are executable by the processor to cause the processor to perform operations comprising: selecting a subset of the historic data that satisfies a relevancy threshold based on relevancy to the active data, wherein the selecting is based on similarities between the number of time series datasets in the active data and the historic data; and creating a predictive composite logging, for a future time period, that includes a number of predictive times series datasets for at least a portion of the number of attributes based on the selected subset of the historic data.

Embodiment #18: The system of Embodiment #17, wherein the selected subset of the historic data comprises historic data from at least two of the number of selected references wells.

Embodiment #19: The system of one or more of Embodiments #17-18, wherein at least a portion of the selected subset of the historic data is from a different depth interval for at least one of the number of selected reference wells as compared to a depth interval of the active well for a previous time period for the active data.

Embodiment #20: The system of one or more of Embodiments #17-19, wherein the active data is for a previous time period for the active well, wherein the previous time period is defined relative to a start of the active drilling operation, wherein at least a portion of the selected subset of the historic data is from a reference time period for at least one of the number of selected reference wells, wherein the reference time period is defined relative to a start of a reference drilling operation of an associated selected reference well, wherein the previous time period is different from the reference time period.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

As used herein, the term “or” is inclusive unless otherwise explicitly noted. Thus, the phrase “at least one of A, B, or C” is satisfied by any element from the set {A, B, C} or any combination thereof, including multiples of any element.

1. A method comprising:
receiving active data of a number of time series datasets for different attributes of an active drilling operation of an active well, for a previous time period having a defined length of time;
retrieving historic data, that corresponds to the active data, of the number of attributes for offset drilling operations of a number of selected reference wells;
selecting a subset of the historic data that satisfies a relevancy threshold based on relevancy to the active data, wherein the selecting is based on similarities between the number of time series datasets in the active data and the historic data; and
creating a predictive composite logging, for a future time period, that includes a number of predictive times series datasets for at least a portion of the different attributes based on the selected subset of the historic data.

2. The method of claim 1, wherein selecting the subset of the historic data that satisfies the relevancy threshold comprises inputting the active data and the historic data into a machine-learning model to output from the machine-learning model the subset of the historic data that satisfies the relevancy threshold.

3. The method of claim 1, wherein the selected subset of the historic data comprises historic data from at least two of the number of selected references wells.

4. The method of claim 1, wherein at least a portion of the selected subset of the historic data is from a different depth interval for at least one of the number of selected reference wells as compared to a depth interval of the active well for the previous time period.

5. The method of claim 1, wherein the previous time period is defined relative to a start of the active drilling operation, wherein at least a portion of the selected subset of the historic data is from a reference time period for at least one of the number of selected reference wells, wherein the reference time period is defined relative to a start of a reference drilling operation of an associated selected reference well, wherein the previous time period is different from the reference time period.

6. The method of claim 1, wherein the predictive composite logging includes at least one non-time series attribute of the number of attributes, wherein the method further comprising:
generating a predictive drilling report for the future time period based on the predictive composite logging.

7. The method of claim 6,
wherein the predictive composite logging includes at least one non-time series attribute of the number of attributes, and
wherein the predictive drilling report comprises at least one text-based prediction of an event predicted to occur in the future time period.

8. The method of claim 6, further comprising:
determining whether the active drilling operation is to be updated based on the predictive drilling report; and
in response to determining that the active drilling operation is to be updated based on the predictive drilling report, updating at least one parameter of the active drilling operation based on the predictive drilling report.

9. The method of claim 1, wherein the number of attributes comprises at least one of a depth of a wellbore, a timestamp, a rate of drilling penetration, a weight on bit, a torque applied to a drill string, rotations per minute of the drill string, an inclination of the wellbore, an azimuth of the wellbore, a stand pipe pressure on the drill string, a pit volume, a connection time, an activity state, and at least one formation log.

10. A non-transitory, computer-readable medium having instructions stored thereon that are executable by a processor to perform operations comprising:
receiving active data of a number of time series datasets for different attributes of an active drilling operation of an active well, for a previous time period having a defined length of time;
retrieving historic data, that corresponds to the active data, of the number of attributes for offset drilling operations of a number of selected reference wells;
selecting a subset of the historic data that satisfies a relevancy threshold based on relevancy to the active data, wherein the selecting is based on similarities between the number of time series datasets in the active data and the historic data; and
creating a predictive composite logging, for a future time period, that includes a number of predictive times series datasets for at least a portion of the different attributes based on the selected subset of the historic data.

11. The non-transitory, computer-readable medium of claim 10, wherein selecting the subset of the historic data that satisfies the relevancy threshold comprises inputting the active data and the historic data into a machine-learning model to output from the machine-learning model the subset of the historic data that satisfies the relevancy threshold.

12. The non-transitory, computer-readable medium of claim 10, wherein the selected subset of the historic data comprises historic data from at least two of the number of selected references wells.

13. The non-transitory, computer-readable medium of claim 10, wherein at least a portion of the selected subset of the historic data is from a different depth interval for at least one of the number of selected reference wells as compared to a depth interval of the active well for the previous time period.

14. The non-transitory, computer-readable medium of claim 10, wherein the previous time period is defined relative to a start of the active drilling operation, wherein at least a portion of the selected subset of the historic data is from a reference time period for at least one of the number of selected reference wells, wherein the reference time period is defined relative to a start of a reference drilling operation of an associated selected reference well, wherein the previous time period is different from the reference time period.

15. The non-transitory, computer-readable medium of claim 10, wherein the operations comprise:
generating a predictive drilling report for the future time period based on the predictive composite logging;
determining whether the active drilling operation is to be updated based on the predictive drilling report; and
in response to determining that the active drilling operation is to be updated based on the predictive drilling report, updating at least one parameter of the active drilling operation based on the predictive drilling report.

16. The non-transitory, computer-readable medium of claim 10, wherein the number of attributes comprises at least one of a depth of a wellbore, a timestamp, a rate of drilling penetration, a weight on bit, a torque applied to a drill string, rotations per minute of the drill string, an inclination of the wellbore, an azimuth of the wellbore, a stand pipe pressure on the drill string, a pit volume, a connection time, an activity state, and at least one formation log.

17. A system comprising:
a drill string to drill an active well as part of an active drilling operation, wherein the drill string comprises a bottom hole assembly that includes a downhole tool to detect active data of at least one attribute of a number of attributes of the active drilling operation;
a logging device to receive active data of the number of attributes of the active drilling operation;
a storage device to store,
an active data collection database that includes the active data of the number of attributes of the active drilling operation in the active data collection database; and
a historic data collection database that includes historic data of the number of attributes for reference drilling operations of a number of selected reference wells;
a processor; and
a computer-readable medium having instructions stored thereon that are executable by the processor to cause the processor to perform operations comprising:
selecting a subset of the historic data that satisfies a relevancy threshold based on relevancy to the active data, wherein the selecting is based on similarities between the number of time series datasets in the active data and the historic data; and
creating a predictive composite logging, for a future time period, that includes a number of predictive times series datasets for at least a portion of the number of attributes based on the selected subset of the historic data.

18. The system of claim 17, wherein the selected subset of the historic data comprises historic data from at least two of the number of selected references wells.

19. The system of claim 17, wherein at least a portion of the selected subset of the historic data is from a different depth interval for at least one of the number of selected reference wells as compared to a depth interval of the active well for a previous time period for the active data.

20. The system of claim 17, wherein the active data is for a previous time period for the active well, wherein the previous time period is defined relative to a start of the active drilling operation, wherein at least a portion of the selected subset of the historic data is from a reference time period for at least one of the number of selected reference wells, wherein the reference time period is defined relative to a start of a reference drilling operation of an associated selected reference well, wherein the previous time period is different from the reference time period.
